(19) United States
(12) Patent Application Publication
(10) Pub. No.: US 2026/0220515 A1
(43) Pub. Date: Jul. 30, 2026

(54) MODULAR EXPANSION ARCHITECTURE FOR QUANTUM COMPUTING SYSTEMS

(71) Applicant: Homatch.ai, Milpitas, CA (US)

(72) Inventor: Mingjun Wang, Saratoga, CA (US)

(21) Appl. No.: 19/463,012

(22) Filed: Jan. 28, 2026

Related U.S. Application Data
(60) Provisional application No. 63/751,185, filed on Jan. 29, 2025.

(51) Int. Cl. G06N 10/40; G06F 9/50

(52) U.S. Cl. CPC G06N 10/40; G06F 9/5088; G06F 2209/501

(57) ABSTRACT

A quantum computing system and a method for controlling the quantum computing system are provided. The quantum computing system includes a rack framework, multiple quantum modules, and one or more inter-module interfaces. The rack framework includes multiple mounting positions. The multiple quantum modules are removably mounted at the plurality of mounting positions of the rack framework. Each inter-module interface is coupled to a corresponding mounted quantum module and configured to transmit quantum information to and from the corresponding mounted quantum module. When some modules become faulty or degraded, they can be removed from the system to prevent negatively impacting overall system efficiency. Meanwhile, new modules can be added by mounting them in the corresponding mounting positions to enhance system performance. In some embodiments of the disclosed quantum computing system, hot-swappable quantum modules can be achieved.

### CROSS-REFERENCE TO RELATED APPLICATIONS

This application claims priority to U.S. Provisional Patent Application Serial No. 63/751,185, filed Jan. 29, 2025, entitled “MODULAR EXPANSION ARCHITECTURE FOR HELICAL PILLAR QUANTUM CHIPS”. This application also has some subject matter relationship to U.S. Application No. 19/435,682, filed Dec. 29, 2025, and International Application No. PCT/US26/11159, filed Jan. 13, 2026. The contents of these applications referenced in this section are hereby incorporated by reference in their entirety for all purposes.

### TECHNICAL FIELD

This disclosure relates to quantum computing devices, including techniques for modular expansion architecture in a quantum computing system.

### BACKGROUND

Quantum computing has emerged as a promising paradigm for solving complex computational problems that are intractable for classical systems. Current quantum processors typically employ qubits based on superconducting circuits, trapped ions, neutral atoms, solid state defect centers, or other elements having quantum states that can be initialized, manipulated, and measured, and rely on quantum entanglement and superposition to perform operations. Despite significant progress, existing architectures face challenges in scalability, error correction, and maintaining coherence over extended computations. Various approaches are being explored to improve qubit fidelity, interconnectivity, and integration into practical computing systems.

### BRIEF DESCRIPTION OF THE DRAWINGS

FIG. 1 is a perspective view of a quantum computing system in accordance with one embodiment of the present disclosure having quantum modules arranged in a planar pattern.

FIG. 2 is a perspective view of a quantum computing system in accordance with one embodiment of the present disclosure having quantum modules arranged in a three-dimensional helical pattern.

FIG. 3 is a diagram illustrating a quantum module including a plurality of quantum nodes and pathways.

FIG. 4 is a flowchart illustrating an example method for controlling a quantum computing system in accordance with embodiments of the present disclosure.

FIG. 5 is a flowchart illustrating an example method for isolating at least one selected quantum module in a quantum computing system in accordance with embodiments of the present disclosure.

FIG. 6 is a flowchart illustrating another example method for reallocating at least one quantum task in accordance with embodiments of the present disclosure.

### DETAILED DESCRIPTION

Aspects of the present disclosure are directed to a quantum computing system. The quantum computing system includes a rack framework and a plurality of quantum modules. Each quantum module includes at least one quantum processing component, which may comprise multiple quantum nodes and pathways. Each quantum node is configured to host one or more qubits and perform local quantum operations, while the pathways are configured to couple pairs of quantum nodes and enable transmission of quantum information between them. The plurality of quantum modules can operate independently, allowing the modules to execute computing tasks in parallel. In this manner, the plurality of quantum modules support distributed quantum processing, state transfer, and coordinated quantum computation across the system.

A quantum computing system may include a large number of quantum modules, making it likely that some modules may become faulty or degraded over time. When one or more quantum modules become faulty or degraded, they may fail to complete, or may delay, the computing tasks assigned to them. This can negatively impact the overall efficiency of the quantum computing system.

To address these and other issues, aspects of the present disclosure provide a quantum computing system and a method performed by the quantum computing system. The quantum computing system includes a rack framework, multiple quantum modules, and one or more inter-module interfaces. The rack framework includes multiple mounting positions. Each mounting position is configured to receive a corresponding quantum module. The multiple quantum modules are removably mounted at the plurality of mounting positions of the rack framework. Each inter-module interface is coupled to a corresponding mounted quantum module and configured to transmit quantum information to and from the corresponding mounted quantum module. When some modules become faulty or degraded, they can be removed from the system to prevent negatively impacting overall system efficiency. Meanwhile, new modules can be added by mounting them in the corresponding mounting positions to enhance system performance. In some embodiments of the disclosed quantum computing system, hot-swappable quantum modules can be achieved.

Furthermore, multiple quantum modules may be different types of quantum modules. The one or more inter-module interfaces may be used to establish quantum communication between two different types of quantum modules. This architecture provides improved system flexibility, the ability to integrate heterogeneous quantum technologies, enhanced scalability, and optimized performance by allowing different quantum modules to perform specialized tasks within the same system.

The disclosed method provides a way to allocate at least one quantum task among a plurality of quantum modules. A system controller monitors operational telemetry of the plurality of quantum modules and allocates quantum tasks based on at least one item of operational telemetry. For example, if a quantum module is overloaded, the system controller may isolate the module and stop allocating tasks to it. This approach improves overall system reliability, efficiency, and load balancing by dynamically adapting task allocation based on module performance.

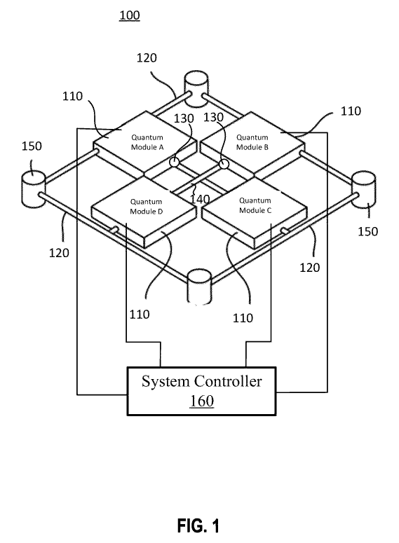

FIG. 1 is a perspective view of a quantum computing system 100 in accordance with one embodiment of the present disclosure having quantum modules 110 arranged in a planar pattern. Quantum computing system 100 includes a rack framework 120, a plurality of quantum modules 110 and one or more inter-module interfaces 130. Rack framework 120 defines a plurality of mounting positions. Each mounting position is configured to receive and support a corresponding quantum module 110. Rack framework 120 may provide mechanical alignment, structural support, and standardized connectivity to enable modular installation, removal, or replacement of quantum modules 110. As shown in FIG. 1, rack framework 120 is a 2D flat rack and has four mounting positions provided on the flat surface of the rack framework 120. Rack framework 120 may further include a plurality of connection channels 140 between different quantum modules 110 via corresponding interfaces 130, such that different modules 110 can communicate (e.g., quantum communication, or electric communication) with each other. For example, a connection channel 140 is coupled between a first mounting position and a second mounting position, such that the connection channel 140 enables two quantum modules 110 mounted on these two positions. In some embodiments, connection channel 140 may include quantum and non-quantum communication links. In one example, the quantum communication link is implemented by a photonic waveguide and the non-quantum communication link is implemented by a conductive wire suitable for electrical signaling. In such an example, a connection channel 140 can enable communication of both quantum and classical information. Other implementations of quantum and classical communication links are well known. Furthermore, in some instances, a waveguide can be used for implementing either a quantum or classical communication link. .

A plurality of quantum modules 110 is removably mounted at the mounting positions of the rack framework 120, such that each quantum module may be independently installed or removed without disassembling the entire system 100. Each quantum module 110 includes at least one quantum processing component, such as a quantum node, qubit array, waveguides or other quantum information processing element, configured to perform quantum operations. Referring to FIG. 1, four quantum modules 110 are mounted at their respective mounting positions. Those quantum modules 110 are hot-swappable, which means they can be mounted and removed when the quantum computing system 100 is operating.

In the example of FIG. 1, the four quantum modules 110 may be different types of quantum modules 110. For example, one or more of the quantum modules 110 may include superconducting quantum modules 110 implementing superconducting qubits operated at cryogenic temperatures, while one or more other quantum modules 110 may include photonic quantum modules 110 configured to generate, manipulate, or detect photonic qubits using optical components such as waveguides, interferometers, or single-photon sources and detectors. In some embodiments, one or more quantum modules 110 may include trapped-ion quantum modules 110 in which qubits are realized using trapped atomic ions controlled by electromagnetic fields, or spin-based quantum modules 110, such as semiconductor quantum dot modules 110 or defect-center modules 110 (e.g., NV centers), in which qubits are encoded in electronic or nuclear spin states. In further embodiments, one or more quantum modules 110 may include neutral-atom quantum modules 110 employing optically trapped atoms, or hybrid quantum modules 110 that integrate multiple qubit modalities or combine quantum processing components with classical control or readout circuitry. Accordingly, the quantum computing system 100 may support heterogeneous quantum architectures in which different types of quantum modules 110 coexist and interoperate within the same rack framework 120.

The system 100 further includes one or more inter-module interfaces 130 provided on or integrated with the rack framework 120. Each inter-module interface is coupled to a corresponding mounted quantum module 110 and is configured to transmit quantum information to and from that quantum module 110. The inter-module interfaces 130 enable communication, coordination, or entanglement-related operations among multiple quantum modules 110.

In some embodiments, the inter-module interfaces 130 support different communication modalities, including optical interfaces 130 for photonic or free-space quantum communication, electrical interfaces 130 for electronic or electrostatic signal exchange, and hybrid quantum–classical communication interfaces 130 that carry both quantum signals and associated classical control and synchronization signals. With these inter-module interfaces 130, communication between different types of quantum modules 110 becomes possible. For example, a superconducting quantum module 110 implementing superconducting qubits may communicate with a photonic quantum module 110 configured to generate, manipulate, or detect photonic qubits using optical components.

By providing inter-module interfaces 130 on rack framework 120 and allowing quantum modules 110 to be removably mounted, quantum computing system 100 supports scalable, reconfigurable, and serviceable quantum computing architectures in which quantum modules 110 may be added, upgraded, or replaced while maintaining system-level interoperability.

A plurality of control and input/output pillars 150 may be provided. These include digital control pillar, analog or bias control pillar, high-speed RF or electro-optic control pillar, and ground, shielding, or thermal control pillar. Control pillars 150 may be mounted on a respective pillar base.

Although, in the example of FIG. 1, the rack framework 120 is illustrated as a two-dimensional flat rack having four mounting positions, in other examples the rack framework 120 may be implemented as a three-dimensional rack and may include more or fewer than four mounting positions. Further, the arrangement and layout of the mounting positions may vary among different examples.

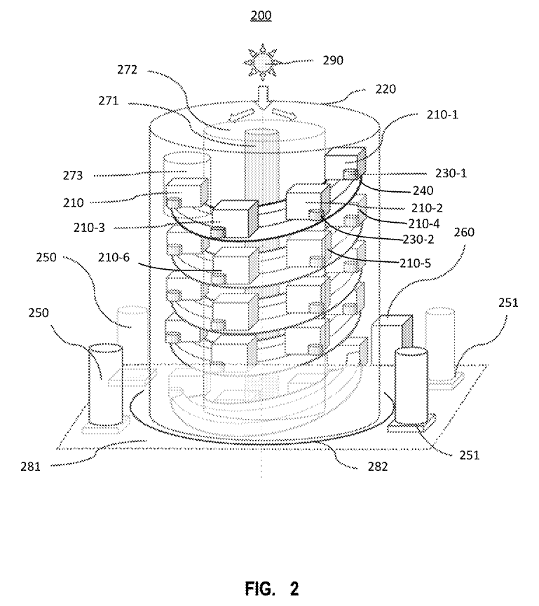

FIG. 2 is a perspective view of a quantum computing system 200 in accordance with one embodiment of the present disclosure having quantum modules 210 arranged in a three-dimensional helical pattern. As shown in FIG. 2, the quantum computing system 200 includes a rack framework 220, a plurality of quantum modules 210, a plurality of inter-module interfaces 230, a support plate 281, a cryogenic interface region 282, entanglement region 271, an axial optical-access region 272, an optical excitation source 290 and multiple control pillars 250.

Referring to FIG. 2, the rack framework 220 is illustrated as a three-dimensional rack. Specifically, the plurality of mounting positions on the rack framework 220 has a helical layout, such that the mounted quantum modules 210 form a helical arrangement. In some embodiments, the helical arrangement might be a dual helix in which some quantum modules are arranged along a first helix of the arrangement and other quantum modules are arranged along a second helix of the arrangement. In some embodiments, the two helices may have an angular offset such that similarly indexed nodes are at a same vertical level but at different angular positions around curves defining the helical structure. In other embodiments, the quantum modules are arranged in quadric sections or in other curved three-dimensional patterns.

The plurality of quantum modules 210 is coupled through a standardized inter-module interface 230. For example, a first quantum module 210-1 is coupled to the plurality of other quantum modules 210 through a first inter-module interface 230-1; while a second quantum module 210-2 is coupled to the plurality of other quantum modules 210 through a second inter-module interface 230-2. The inter-module interfaces 230 enable communication, coordination, and signal exchange among the quantum modules 210. The quantum computing system 200 further includes communication channels 240 configured to transmit quantum information between different inter-module interfaces 230. In some examples, the communication channels 240 may be waveguide. In some other embodiments, the communication channel 240 may include both quantum and electric wire, such that they enable both quantum communication and electric communication.

The quantum computing system 200 further includes a system controller 260 that coordinates task allocation, scheduling, and operational control across the plurality of quantum modules 210. The system controller 260 is coupled to multiple quantum modules 210 and configured to obtain at least one item of operational telemetry from the multiple quantum modules 210. After receiving the operational telemetry, the system controller 260 may allocate at least one quantum task among the plurality of quantum modules based on the at least one item of operational telemetry.

The quantum modules 210 and associated interfaces 230 may be mechanically supported and aligned by a support plate 281, while a cryogenic interface region 282 is arranged as a lower interface region configured to provide thermal coupling to a cryogenic heat sink, cold plate, or CryoBase to maintain the quantum modules 210 at desired operating temperatures.

In some embodiments, one or more quantum modules 210 are configured as part of entanglement region 271 to participate in entanglement generation, measurement, or processing operations among multiple quantum modules. An electrical control layer may be disposed within the quantum system 200 and include electrical routing, control buses, bias distribution networks, synchronization channels, and shielding structures for coordinating quantum module operation. The term “entanglement module,” as used herein, refers to a functional unit or module within the quantum computing system 200 that is configured to generate, measure, or process entangled quantum states by, for example, performing Bell-state measurement, entanglement swapping, or entanglement purification.

The system 200 may further define an axial optical-access region 272 forming a central unobstructed optical path. Referring to FIG. 2, the optical-access region 272 is a cylindrical region extending along the axis of the system 200. An optical excitation source 290 (e.g., an external or integrated laser) may be provided on the top of the optical-access region 272 and emits light going through the optical-access region 272. The light then may be directed toward one or more quantum nodes in the plurality of the quantum modules 210 for excitation, measurement, or control.

A plurality of control and input/output pillars 250 may be provided. These include digital control pillar, analog or bias control pillar, high-speed RF or electro-optic control pillar, and ground, shielding, or thermal control pillar. Control pillars 250 are mounted on a respective pillar base 251. Pillar bases 251 (a respective base 251 supporting a respective one of control pillars 250) are provided on support plate 281, along with the cylindrical assembly including and within the rack framework 220.

In some embodiments, the system 200 further includes an optional modular cryogenic region 273 that enables modular integration with additional cryogenic components or subsystems, thereby supporting scalable, flexible, and thermally efficient quantum computing architectures.

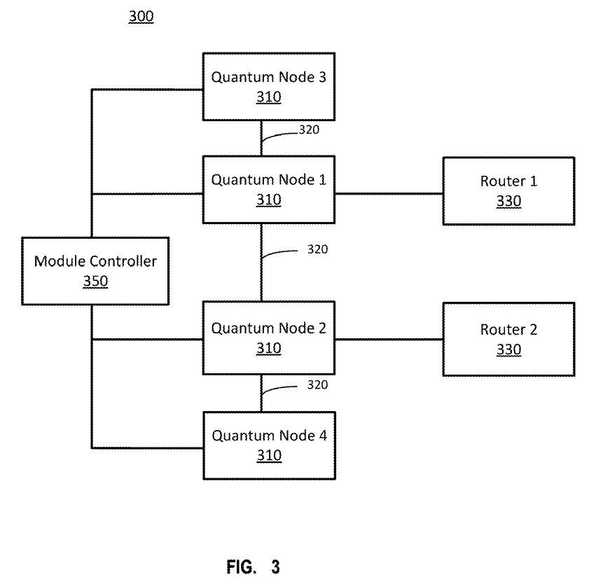

FIG. 3 is a diagram illustrating a quantum module 300 including a plurality of quantum nodes 310 and pathways 320. The quantum module 300 may be an example of a quantum module 110 shown in FIG. 1 or a quantum module 210 shown in FIG. 2.

As shown in FIG. 3, the quantum module 300 includes a plurality of quantum nodes 310 and a plurality of pathways 320 coupling the quantum nodes 310. The quantum nodes 310 and the pathways 320 are formed on a common substrate, such as a semiconductor substrate, a dielectric substrate, or a photonic integrated circuit platform. Each quantum node is configured to contain, generate, store, or manipulate at least one qubit, including, for example, a photonic qubit, an electronic qubit, a spin qubit, a superconducting qubit, or another quantum state carrier. The pathways 320 are configured to provide quantum communication channels between the quantum nodes 310 and to transmit quantum information while preserving quantum coherence.

Each quantum node 310 includes a qubit confinement region configured to host a qubit, one or more control elements configured to initialize, manipulate, or measure the qubit, and one or more node interfaces coupled to the pathways 320. In photonic implementations, a quantum node may include one or more photon sources, resonators, beam splitters, phase shifters, or photon detectors. In electronic or spin-based implementations, a quantum node may include one or more quantum dots, traps, superconducting circuits, or spin confinement structures. Each quantum node may be configured to perform local quantum operations, including single-qubit gate operations, state preparation operations, and measurement operations. In certain embodiments, each quantum node 310 is provided on a quantum node island. The quantum node island may include only the quantum node core itself or may additionally include local coupling structures, modulators, detectors, or conditioning circuitry. A quantum node island is a localized platform or structure that supports the quantum node 310 and its associated components and is spatially separated from other device elements to enhance isolation from external interference, thermal fluctuations, or electromagnetic noise. Examples of quantum node islands may include, without limitation, microfabricated platforms, suspended chips, or isolated dielectric regions that support the integration of quantum node cores and their control devices. Modulation and routing elements may be integrated within the node island such as node 310, and/or within a photonic routing layer adjacent to the node island.

The pathways 320 coupling the quantum nodes 310 may include optical waveguides, microwave transmission lines, superconducting interconnects, or other structures capable of transmitting quantum states between nodes 310. In some embodiments, a pathway is configured to transmit information from a first quantum node to a second quantum node. In some embodiments, the pathways 320 mediate quantum interactions between qubits located at different quantum nodes 310, such as generating entanglement or enabling quantum interference. The pathways 320 may be passive or may include active elements, such as tunable couplers, switches, or phase modulators, to control the flow of quantum information between quantum nodes 310.

In operation, a quantum computing process performed by the quantum computing chip may include initializing qubits at one or more quantum nodes 310 into predetermined quantum states, such as ground states, superposition states, or entangled states. Initialization may be performed using optical excitation, electrical biasing, microwave pulses, or other control signals applied to the quantum nodes 310. After initialization, quantum states may be distributed among quantum nodes 310 through one or more pathways 320. For example, quantum information generated at a first quantum node may be transmitted through a pathway 320 to a second quantum node, or qubits at multiple quantum nodes 310 may become entangled through interactions mediated by the pathways 320.

Quantum operations may be performed by applying control signals to individual quantum nodes 310 to implement local quantum gate operations and by coordinating interactions between multiple quantum nodes 310 through pathways 320 to implement multi-qubit gate operations. The timing, amplitude, phase, and coupling strength of signals associated with pathways 320 may be controlled to execute a desired quantum algorithm. During the quantum computing process, pathways 320 may be dynamically reconfigured to alter communication patterns between quantum nodes 310, such as redirecting qubits to different quantum nodes 310 or selectively enabling or disabling interactions between selected pairs of quantum nodes 310.

After completion of the quantum operations, one or more quantum nodes 310 may perform measurement operations to convert quantum states into classical information. Measurement results may be transmitted to on-chip or off-chip classical control circuitry for further processing, error correction, or output generation. In some embodiments, quantum computing module 300 supports scalability by increasing the number of quantum nodes 310, increasing the number of pathways 320 coupled to each quantum node, or arranging quantum nodes 310 in one-dimensional, two-dimensional, or three-dimensional network topologies. The node-and-pathway architecture enables modular expansion of the quantum computing chip while maintaining controlled quantum interactions and reducing decoherence and crosstalk.

In some embodiments, a quantum module includes routing functionality configured to control the transmission of quantum information between quantum nodes 310. As used herein, “routing” refers to selectively determining and controlling one or more pathways 320 through which quantum states are transmitted between quantum nodes 310 during a quantum computing process. Routing does not necessarily modify the logical state of a qubit, but instead governs the spatial, temporal, or logical flow of quantum information within the module. As shown in FIG. 3, the quantum device 300 further includes multiple routers 330. Routers 330 (e.g., photonic routers) may be disposed at selected locations in a routing network. Routers 330 that are illustrated in FIG. 3 may be configurable to direct photons from quantum nodes 310 to different routing paths (not shown in FIG. 3 to avoid overcomplicating the drawing). This arrangement supports flexible routing of photonic signals for quantum operations, entanglement distribution, measurement, and fault tolerance (e.g., redundancy or fallback routing).

Routing may be used to establish, modify, or terminate communication links between selected quantum nodes 310. In some embodiments, routing determines which quantum nodes 310 are coupled at a given time, the sequence in which quantum nodes 310 interact, and pathways 320 over which qubits or quantum states are transmitted. Through routing, the quantum computing system can dynamically reconfigure connectivity between quantum nodes 310 to support different stages of a quantum algorithm.

Routing serves several functions in a quantum computing process. In some embodiments, routing enables quantum information generated or stored at a first quantum node to be delivered to a second quantum node that is not directly adjacent or permanently coupled to the first quantum node. In some embodiments, routing enables multi-qubit operations by selectively enabling coupling between specific pairs or groups of quantum nodes 310 while isolating other quantum nodes 310 to prevent unintended interactions. Routing may also reduce crosstalk, decoherence, or noise by disabling unused pathways 320 or limiting coupling durations to predefined time windows.

In operation, routing may be performed before, during, or between quantum gate operations. For example, a routing operation may be executed to connect two quantum nodes 310 prior to performing a two-qubit gate operation, and subsequently executed to decouple the quantum nodes 310 after completion of the gate operation. In some embodiments, routing operations are interleaved with quantum state manipulation operations as part of a larger quantum computing sequence.

As mentioned above, routing may be implemented using one or more routers 330 integrated into quantum modules 300. In some other embodiments, routing may be performed by one or more tunable coupling elements, switches, or modulators disposed along pathways 320 between quantum nodes 310. For photonic implementations, routing components (e.g., routers 330) may include optical switches, directional couplers, multiplexers, demultiplexers, or phase-controlled waveguide elements. For electronic or superconducting implementations, routing components may include tunable capacitive or inductive couplers, controllable transmission lines, or gate-controlled transport structures. In some embodiments, routing is performed by controlling temporal parameters, such as timing or sequencing of signals, such that quantum states share a common pathway at different times.

In some embodiments, routing is controlled by classical control circuitry associated with the quantum module. The classical control circuitry may generate routing control signals that configure routing components to establish desired pathways 320 between quantum nodes 310. Routing decisions may be predetermined based on a compiled quantum algorithm, dynamically determined based on intermediate measurement results, or adjusted to compensate for hardware conditions such as faulty nodes 310 or pathways 320.

Accordingly, routing enables flexible and scalable quantum computation by allowing a limited set of physical pathways 320 to support a larger set of logical interactions between quantum nodes 310. By separating routing functionality from quantum state manipulation functionality, the quantum module 300 can efficiently coordinate complex quantum algorithms while maintaining control over coherence, interaction locality, and system resources.

The quantum module 300 further includes a module controller 350 coupled to the quantum nodes 310 and configured to receive data from the quantum nodes 310. The module controller 350 is also communicatively connected to the system controller of the quantum computing system. When the system controller assigns tasks to the quantum module 300, the module controller 350 receives task information associated with those tasks. Accordingly, the module controller 350 is aware of the workload condition of the quantum module 300, such as the number of tasks in a pending task queue, or an estimated completion time (e.g., expressed in milliseconds) for tasks currently queued at the quantum module. The module controller 350 also receives data associated with the quantum nodes. For example, the module controller 350 may obtain the temperature of a quantum node and calculate a temperature headroom between a current operating temperature of the quantum module and a thermal limit. As another example, the module controller 350 may detect errors at each quantum node and report the errors to the system controller. In some embodiments, different sensors may be provided in the quantum nodes to facilitate acquisition of the parameters described above. For example, a temperature sensor may be disposed on a quantum node to detect its temperature.

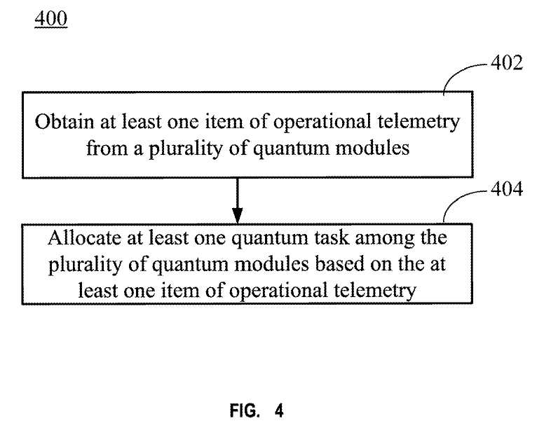

FIG. 4 is a flowchart illustrating an example method 400 for controlling a quantum computing system in accordance with embodiments of the present disclosure. The quantum computing system may be an example of quantum computing system 100 shown in FIG. 1 or quantum computing system 200 shown in FIG. 2. The quantum computing system includes a plurality of quantum modules communicatively coupled to a system controller. Each quantum module reports, on a periodic or an event-driven basis, at least one item of operational telemetry indicative of its operating state. At least one item of operational telemetry may include workload condition; computational capacity; module health status, or fault-detection information. The workload condition may indicate a number of quantum tasks currently residing in, queued at, or being processed by the quantum module. The computational capacity may indicate an available or total processing capability of the quantum module, such as a number of quantum processing components (e.g., quantum nodes, or qubits) included in the quantum module, or the amount of available processing headroom. The module health status may indicate whether the quantum module is operating normally or is degraded, for example due to thermal stress, calibration drift, or performance degradation. Fault-detection information may indicate whether the quantum module is malfunctioning or has experienced a detected or predicted fault, such as a hardware failure, communication error, or control error. At block 402, the system controller obtains at least one item of operational telemetry from a plurality of quantum modules.

At block 404, the system controller allocates at least one quantum task among the plurality of quantum modules based on the at least one item of operational telemetry. After obtaining the operational telemetry, the system controller allocates at least one quantum task among the plurality of quantum modules based on the at least one item of operational telemetry. For example, if the system controller determines that a quantum module is heavily loaded, the system controller may reduce a number of tasks allocated to that quantum module, whereas if the system controller determines that a quantum module is idle or lightly loaded, the system controller may increase the number of tasks allocated to that quantum module. Similarly, if the system controller determines that a module health status of a quantum module is degraded, the system controller may reduce task allocation to the quantum module, whereas if the quantum module is determined to be in a healthy operating condition, the system controller may increase task allocation to that quantum module. In addition, if the system controller determines that a quantum module has relatively low computational capacity, the system controller may reduce task allocation to that quantum module, whereas if the quantum module is determined to have relatively high computational capacity, the system controller may increase task allocation to the quantum module.

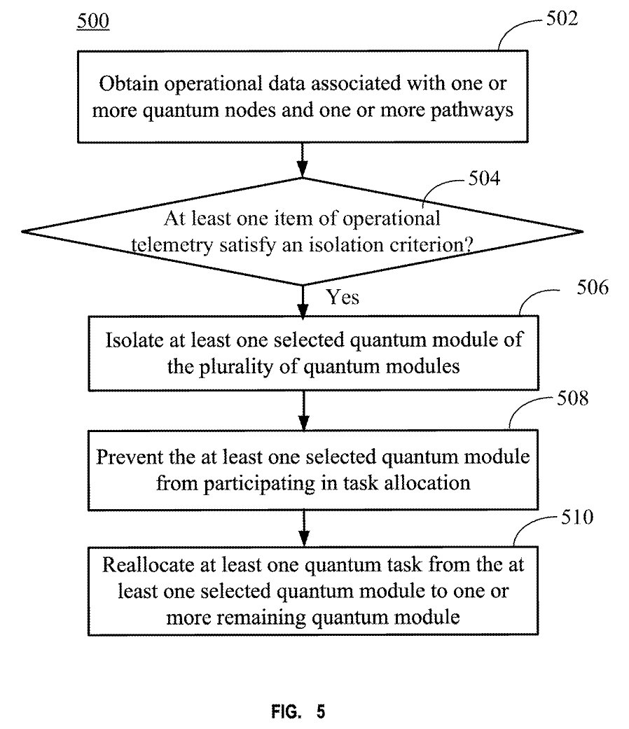

FIG. 5 is a flowchart illustrating an example method 500 for isolating at least one selected quantum module in a quantum computing system in accordance with embodiments of the present disclosure. The quantum computing system may be an example of quantum computing system 100 shown in FIG. 1 or quantum computing system 200 shown in FIG. 2. Block 502 may be similar to block 402, as previously described in the context of FIG. 4, and the detailed description of it is therefore not repeated here. The quantum computing system includes a plurality of quantum modules communicatively coupled to a system controller.

At block 504, the system controller determines, for each quantum module, whether at least one item of operational telemetry satisfies an isolation criterion. The isolation criteria may include, but are not limited to: a quantum module being overloaded or malfunctioning; a computational capacity of a quantum module falling below a threshold; a module health status falling below a threshold; and fault-detection information being received by the system controller.

In some examples, the system controller determines whether a quantum module is overloaded based on the workload condition of the quantum module. The workload may be determined by at least one workload parameter (e.g., queue depth, estimated completion time for pending tasks, utilization of resources, thermal margin, an error indicator, and a link congestion indicator). In some examples, the workload may be represented by a workload score calculated by these detected workload parameters. The workload score for a given module may be normalized or aggregated into a workload vector that includes multiple measured workload parameter associated with that module.

For example, the telemetry may be normalized into a workload vector:

Li=[q(i), w(i), u(i), θ(i), e(i), ℓ(i),…]

where the index i denotes a corresponding quantum module. The parameter q(i) represents a queue depth indicative of an amount of pending tasks. The parameter w(i) represents an estimated completion time (e.g., expressed in milliseconds) for tasks currently queued at the quantum module. The parameter u(i) represents a utilization level of the quantum module, such as a fraction or percentage of time that one or more critical resources of the quantum module are actively engaged. The parameter θ(i) represents a thermal margin of the quantum module, which may correspond to a temperature headroom between a current operating temperature of the quantum module and a thermal limit. A smaller thermal margin indicates reduced thermal headroom and a higher risk of thermal throttling, increased noise, or device degradation. The parameter e(i) represents an error indicator that quantifies an observed or predicted error condition of the quantum module, such as error rate, or fault probability, wherein a higher value indicates worse reliability or higher error risk. The parameter ℓ(i) represents a link congestion indicator associated with communication links coupled to the quantum module, such as interconnect bandwidth utilization, packet loss, latency inflation, or contention level, wherein a higher value indicates greater congestion or reduced communication capacity.

In general, a larger queue depth q(i) and a longer estimated completion time w(i) contribute to a higher overload score for the quantum module. Likewise, a higher utilization u(i), a smaller thermal margin θ(i), a higher error indicator e(i), and a higher link congestion indicator ℓ(i) each contribute to an increased overload score, reflecting reduced processing headroom, diminished reliability, or constrained communication capability of the quantum module.

In some embodiments, the system controller may compute a workload score for each module using a weighted function applied to one or more components of the module workload vector. The weights and normalization functions may be configurable to reflect system-level priorities, such as latency sensitivity, thermal constraints, or reliability considerations. For example, if the quantum computing system prioritizes low latency, the estimated completion time w(i) may be assigned a relatively higher weight. If the quantum computing system prioritizes thermal management, the thermal margin θ(i) may be assigned a relatively higher weight.

A quantum module may be determined to be overloaded when an overload score of the quantum module exceeds a first threshold score for a predetermined number of reporting intervals, or when any of the workload parameters exceeds a corresponding limit. For example, the first threshold score may be set to a value S1. When the overload score exceeds S1, the system controller determines that the quantum module is overloaded and may isolate the quantum module. As another example, a pending-task queue depth of a quantum module may be subject to a hard limit, such as a maximum of ten tasks. When the pending-task queue depth exceeds the hard limit, the system controller determines that the quantum module is overloaded and may isolate the quantum module.

To improve stability and avoid oscillation, a hysteresis mechanism may be employed, such that the overloaded condition is cleared only when the overload score falls below a lower threshold for a specified duration. In some embodiments, the controller further computes a predicted overload score using historical telemetry trends or a learned model to enable preemptive mitigation before performance degradation occurs.

At block 506, The system controller isolates, in response to the at least one item of operational telemetry satisfying an isolation criterion, at least one selected quantum module of the plurality of quantum modules. For example, when the system controller determines that a quantum module is overloaded, the system controller may isolate the quantum module. In some examples, the inter-module interfaces provided on the rack framework may include switches that are configured to control the connection of the corresponding quantum module. In these examples, the system controller may control the switches to isolate the selected quantum modules.

At block 508 and block 510, after the selected quantum modules are isolated, the system controller may further stop allocating tasks to the selected quantum modules and may further reallocate tasks assigned to the quantum module to one or more other quantum modules, thereby ensuring that tasks are completed successfully and efficiently.

In one embodiment, a dual-helix architecture of a quantum computing system can enable efficient reallocation of the tasks. For example, when a quantum module located in a first helix is isolated, the system controller may reallocate the tasks residing in the quantum module to an alternative quantum module located in the second helix which may be vertically aligned below the first quantum module. In such an example, a dual-helix structure allows tasks to be readily reallocated between quantum nodes in the two helices, thereby enhancing reallocation flexibility and fault tolerance of the quantum computing system.

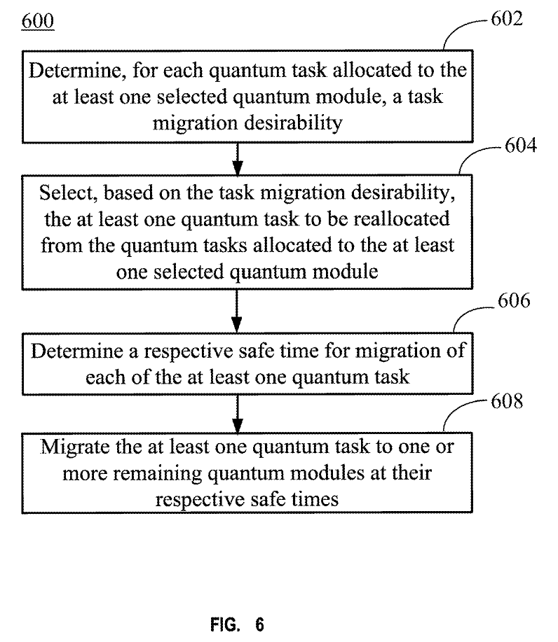

FIG. 6 is a flowchart illustrating an example method 600 for reallocating at least one quantum task in accordance with embodiments of the present disclosure.

At block 602, when reallocating at least one quantum task, the system controller may determine, for each quantum task allocated to the at least one selected quantum module, a task migration desirability.

Specifically, each task allocated by the system controller is associated with a task descriptor that defines attributes including task class, priority, estimated remaining execution time, migratability, migration cost, affinity constraints, and state characteristics. The migration desirability can be determined based on these attributes.

Task class indicates a type of operation performed by the task (e.g., measurement, entanglement, communication or calibration). A task priority indicates relative importance or urgency of the task. A migratability indicator specifies whether the task is eligible for migration. An estimated migration cost indicates overhead incurred to migrate or restart the task. Affinity constraints indicate whether the task is required or preferred to remain co-located with particular tasks or resources. The state characteristics indicate whether the task is stateless, checkpointable, or stateful.

In some examples, the system controller may calculate a migration desirability score for all the tasks assigned to the selected quantum module (e.g., overloaded module, or degraded module). The migration desirability score for each task is based on one or more of the task attributes. For example, tasks having a longer estimated remaining execution time, higher priority, or higher fault or deadline risk may be assigned a higher migration desirability score, while tasks having a higher migration cost, stronger affinity constraints, or non-migratable or stateful characteristics may be assigned a lower migration desirability score. The migration desirability score may be computed using a weighted combination of the task attributes, and tasks having higher migration desirability scores may be preferentially selected for reallocation when a quantum module is isolated or overloaded.

At block 604, the system controller then selects, based on the task migration desirability, at least one quantum task to be reallocated from the quantum tasks allocated to the at least one selected quantum module. In some examples, the system controller may select quantum tasks whose migration desirability scores exceed a second threshold score as tasks to be reallocated. In other examples, the system controller may, for each selected quantum module, rank quantum tasks assigned to the selected quantum module (e.g., overloaded or degraded) based on their respective migration desirability scores and select a predetermined number of tasks having the highest migration desirability scores for reallocation.

At block 606, after the tasks to be reallocated are identified, the system controller further determines a respective safe time for migration of each of the at least one quantum task. The system controller then migrates the at least one quantum task to one or more remaining quantum modules at their respective safe times.

Tasks may further specify a state mode and a safe-point policy that together define when the task may be migrated without violating causing inconsistent hardware states. A task is eligible for migration when it reaches a safe point, such as a task boundary, a control-cycle boundary, completion of a valid checkpoint, or a non-interacting interval during which the task does not hold exclusive resources or perform critical operations. Tasks that are have a pinned state, are non-migratable, or are executing within non-interruptible regions are excluded from migration.

For each task to be reallocated, the system determines a destination module by evaluating candidate modules based on current load, topological proximity, reliability state, and affinity constraints, subject to acceptance thresholds that ensure sufficient capacity and operational health at the destination. Upon migration, scheduling and state mappings are updated to reflect the new task placement. By enforcing safe-point gating, desirability-based ranking, and controlled migration limits, the system achieves dynamic load balancing and fault mitigation while preserving execution correctness and minimizing disruption.

At block 608, the system controller migrates the at least one quantum task to one or more remaining quantum modules at their respective safe times.

It should be noted that the described techniques include possible implementations, and that the operations and the blocks may be rearranged, reordered, or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

Processors described herein may be implemented as CPUs, GPUs, DSPs, ASICs, FPGAs, systolic arrays, or hybrid accelerators. References to specific hardware blocks (e.g., FFT unit, CNN engine, LSTM engine) are provided for illustration and do not limit the architecture to any particular implementation.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

### ADDITIONAL EXAMPLES

Example 1: A quantum computing system comprising: a rack framework comprising a plurality of mounting positions, each mounting position configured to receive a corresponding quantum module; a plurality of quantum modules removably mounted at the plurality of mounting positions of the rack framework, each quantum module comprising at least one quantum processing component; and one or more inter-module interfaces provided on the rack framework, each inter-module interface coupled to a corresponding mounted quantum module and configured to facilitate communication of information, including quantum information, to and from its corresponding quantum module.

Example 2: The quantum computing system of example 1, further comprising: a system controller, which is centralized or distributed, communicatively coupled to the plurality of quantum modules via the one or more inter-module interfaces and configured to: obtain at least one item of operational telemetry from the plurality of quantum modules; allocate at least one quantum task among the plurality of quantum modules based on the at least one item of operational telemetry.

Example 3: The quantum computing system of example 2, wherein the system controller is further configured to: isolate, in response to the at least one item of operational telemetry satisfying an isolation criterion, at least one selected quantum module of the plurality of quantum modules.

Example 4: The quantum computing system of example 3, wherein the at least one item of operational telemetry includes at least one item related to a corresponding quantum module selected from: a workload condition; a computational capacity; a module health status, or fault-detection information.

Example 5: The quantum computing system of example 4, wherein the workload condition is determined based on at least one workload parameter related to the corresponding quantum module selected from: a pending task queue depth; an estimated completion time for pending tasks; utilization of resources; a thermal margin; an error indicator; or a link congestion indicator.

Example 6: The quantum computing system of example 5, wherein the workload condition includes an overload score, and wherein the isolation criterion comprises at least one of: the overload score of the selected quantum module exceeding a first threshold score; or any of the workload parameters exceeding a corresponding limit.

Example 7: The quantum computing system of any of examples 3-6, wherein the isolation of the at least one selected quantum module comprises: preventing the at least one selected quantum module from participating in task allocation.

Example 8: The quantum computing system of any of examples 3-7, wherein the isolation of the at least one selected quantum module further comprises: reallocating at least one quantum task from the at least one selected quantum module to one or more remaining quantum module.

Example 9: The quantum computing system of example 8, wherein the reallocation of the at least one quantum task comprises: determining, for each quantum task allocated to the at least one selected quantum module, a task migration desirability score or ranking; and selecting, based on the task migration desirability score or ranking, the at least one quantum task to be reallocated from the quantum tasks allocated to the at least one selected quantum module.

Example 10: The quantum computing system of any of examples 8-9, wherein the reallocation of the at least one quantum task further comprises: determining a respective safe time for migration of each of the at least one quantum task; and migrating the at least one quantum task to one or more remaining quantum modules at their respective safe times.

Example 11: The quantum computing system of any of examples 1-10, wherein the at least one quantum processing component comprises: a plurality of quantum nodes, each quantum node including a qubit confinement region configured to host at least one qubit; and at least one pathway, each pathway coupled between two quantum nodes in the plurality of quantum nodes and configured to enable transmission of quantum information between the two quantum nodes.

Example 12: The quantum computing system of example 11, wherein the at least one quantum processing component further comprises: at least one routing member provided on the at least one pathway and configured to control the transmission of quantum information between quantum nodes.

Example 13: The quantum computing system of any of examples 11-12, wherein the plurality of quantum modules are arranged in a curved three-dimensional pattern.

Example 14: The quantum computing system of example 13 wherein the curved three-pattern is helical.

Example 15: The quantum computing system of any of examples 1-14, wherein each inter-module interface comprises at least one of: an optical interface; an electrical interface; or a hybrid quantum–classical communication interface.

Example 16: The quantum computing system of any of examples 1-15, wherein at least two quantum modules of the plurality of quantum modules are different types of quantum modules.

Example 17: A method for controlling a quantum computing system comprising a plurality of quantum modules, the method comprising: obtaining at least one item of operational telemetry from one or more of the plurality of quantum modules, each quantum module comprising at least one quantum processing component; and allocating at least one quantum task among the plurality of quantum modules based on the at least one item of operational telemetry.

Example 18: The method of example 17, further comprising: isolating, in response to the at least one item of operational telemetry satisfying an isolation criterion, at least one selected quantum module of the plurality of quantum modules.

Example 19: The method of example 18, wherein the at least one item of operational telemetry includes at least one item related to a corresponding quantum module selected from: a workload condition; a computational capacity; a module health status, or fault-detection information.

Example 20: The method of example 19, wherein the workload condition is determined based on at least one workload parameter related to the corresponding quantum module selected from: a pending task queue depth; an estimated completion time for pending tasks; utilization of resources; a thermal margin; an error indicator; or a link congestion indicator.

Example 21: The method of example 20, wherein the workload condition includes an overload score, and wherein the isolation criterion comprises at least one of: the overload score of the selected quantum module exceeding a first threshold score; or any of the workload parameters exceeding a corresponding limit.

Example 22: The method of any of examples 18-21, wherein the isolation of the at least one selected quantum module comprises: preventing the at least one selected quantum module from participating in task allocation.

Example 23: The method of example 22, wherein the isolation of the at least one selected quantum module comprises: reallocating at least one quantum task from the at least one selected quantum module to one or more remaining quantum module.

Example 24: The method of any of examples 17-23, wherein the at least one quantum processing component comprises: a plurality of quantum nodes, each quantum node including a qubit confinement region configured to host at least one qubit; and at least one pathway, each pathway coupled between two quantum nodes in the plurality of quantum nodes and configured to enable transmission of quantum information between the two quantum nodes.

Example 25: The method of any of examples 17-24, wherein the at least one quantum processing component further comprises: at least one routing member provided on the at least one pathway and configured to control the transmission of quantum information between quantum nodes.

Example 26: The method of any of examples 17-25, wherein the plurality of quantum modules collectively define a curved or helical three-dimensional routing structure.

Example 27: The method of any of examples 17-26, wherein the quantum computing system further comprises one or more inter-module interfaces, each inter-module interface coupled to a corresponding mounted quantum module and configured to transmit quantum information to and from the corresponding quantum module, and wherein each inter-module interface comprises at least one of: an optical interface; an electrical interface; or a hybrid quantum–classical communication interface.

Example 28: A method for controlling a quantum computing system comprising a plurality of quantum modules, the method comprising: determining, for each quantum task allocated to at least one selected quantum module, a task migration desirability score or ranking; and selecting, based on the task migration desirability score or ranking, at least one quantum task to be reallocated from quantum tasks allocated to the at least one selected quantum module.

Example 29: The method of example 28, further comprising: determining a respective safe time for migration of each of the at least one quantum task; and migrating the at least one quantum task to one or more remaining quantum modules at their respective safe times.

While the present disclosure has been particularly described with respect to the illustrated embodiments, it will be appreciated that various alterations, modifications, and adaptations may be made based on the disclosure and are intended to be within the scope of the disclosure. While the disclosure has been described in connection with what are presently considered to be the most practical and preferred embodiments, it is to be understood that the present disclosure is not limited to the disclosed embodiments but, on the contrary, is intended to cover various modifications and equivalent arrangements included within the scope of the underlying principles of the invention as described by the various embodiments referenced above and below.

What is claimed is:

1. A quantum computing system comprising:
a rack framework comprising a plurality of mounting positions, each mounting position configured to receive a corresponding quantum module;
a plurality of quantum modules removably mounted at the plurality of mounting positions of the rack framework, each quantum module comprising at least one quantum processing component; and
one or more inter-module interfaces provided on the rack framework, each inter-module interface coupled to a corresponding mounted quantum module and configured to facilitate communication of information, including quantum information, to and from its corresponding quantum module.

2. The quantum computing system of claim 1, further comprising:
a system controller, which is centralized or distributed, communicatively coupled to the plurality of quantum modules via the one or more inter-module interfaces and configured to:
obtain at least one item of operational telemetry from the plurality of quantum modules;
allocate at least one quantum task among the plurality of quantum modules based on the at least one item of operational telemetry.

3. The quantum computing system of claim 2, wherein the system controller is further configured to:
isolate, in response to the at least one item of operational telemetry satisfying an isolation criterion, at least one selected quantum module of the plurality of quantum modules.

4. The quantum computing system of claim 3, wherein the at least one item of operational telemetry includes at least one item related to a corresponding quantum module selected from:
a workload condition;
a computational capacity;
a module health status, or
fault-detection information.

5. The quantum computing system of claim 4, wherein the workload condition is determined based on at least one workload parameter related to the corresponding quantum module selected from:
a pending task queue depth;
an estimated completion time for pending tasks;
utilization of resources;
a thermal margin;
an error indicator; or
a link congestion indicator.

6. The quantum computing system of claim 5, wherein the workload condition includes an overload score, and wherein the isolation criterion comprises at least one of:
the overload score of the selected quantum module exceeding a first threshold score; or
any of the workload parameters exceeding a corresponding limit.

7. The quantum computing system of claim 3, wherein the isolation of the at least one selected quantum module comprises:
preventing the at least one selected quantum module from participating in task allocation.

8. The quantum computing system of claim 7, wherein the isolation of the at least one selected quantum module further comprises:
reallocating at least one quantum task from the at least one selected quantum module to one or more remaining quantum module.

9. The quantum computing system of claim 8, wherein the reallocation of the at least one quantum task comprises:
determining, for each quantum task allocated to the at least one selected quantum module, a task migration desirability score or ranking; and
selecting, based on the task migration desirability score or ranking, the at least one quantum task to be reallocated from the quantum tasks allocated to the at least one selected quantum module.

10. The quantum computing system of claim 9, wherein the reallocation of the at least one quantum task further comprises:
determining a respective safe time for migration of each of the at least one quantum task; and
migrating the at least one quantum task to one or more remaining quantum modules at their respective safe times.

11. The quantum computing system of claim 1, wherein the at least one quantum processing component comprises:
a plurality of quantum nodes, each quantum node including a qubit confinement region configured to host at least one qubit; and
at least one pathway, each pathway coupled between two quantum nodes in the plurality of quantum nodes and configured to enable transmission of quantum information between the two quantum nodes.

12. The quantum computing system of claim 11, wherein the at least one quantum processing component further comprises:
at least one routing member provided on the at least one pathway and configured to control the transmission of quantum information between quantum nodes.

13. The quantum computing system of claim 11, wherein
the plurality of quantum modules are arranged in a curved three-dimensional pattern.

14. The quantum computing system of claim 13 wherein the curved three-pattern is helical.

15. The quantum computing system of claim 1, wherein each inter-module interface comprises at least one of:
an optical interface;
an electrical interface; or
a hybrid quantum–classical communication interface.

16. The quantum computing system of claim 1, wherein at least two quantum modules of the plurality of quantum modules are different types of quantum modules.

17. A method for controlling a quantum computing system comprising a plurality of quantum modules, the method comprising:
obtaining at least one item of operational telemetry from one or more of the plurality of quantum modules, each quantum module comprising at least one quantum processing component; and
allocating at least one quantum task among the plurality of quantum modules based on the at least one item of operational telemetry.

18. The method of claim 17, further comprising:
isolating, in response to the at least one item of operational telemetry satisfying an isolation criterion, at least one selected quantum module of the plurality of quantum modules.

19. The method of claim 18, wherein the at least one item of operational telemetry includes at least one item related to a corresponding quantum module selected from:
a workload condition;
a computational capacity;
a module health status, or
fault-detection information.

20. The method of claim 19, wherein the workload condition is determined based on at least one workload parameter related to the corresponding quantum module selected from:
a pending task queue depth;
an estimated completion time for pending tasks;
utilization of resources;
a thermal margin;
an error indicator; or
a link congestion indicator.

21. The method of claim 20, wherein the workload condition includes an overload score, and wherein the isolation criterion comprises at least one of:
the overload score of the selected quantum module exceeding a first threshold score; or
any of the workload parameters exceeding a corresponding limit.

22. The method of claim 18, wherein the isolation of the at least one selected quantum module comprises:
preventing the at least one selected quantum module from participating in task allocation.

23. The method of claim 22, wherein the isolation of the at least one selected quantum module comprises:
reallocating at least one quantum task from the at least one selected quantum module to one or more remaining quantum module.

24. The method of claim 17, wherein the at least one quantum processing component comprises:
a plurality of quantum nodes, each quantum node including a qubit confinement region configured to host at least one qubit; and
at least one pathway, each pathway coupled between two quantum nodes in the plurality of quantum nodes and configured to enable transmission of quantum information between the two quantum nodes.

25. The method of claim 17, wherein the at least one quantum processing component further comprises:
at least one routing member provided on the at least one pathway and configured to control the transmission of quantum information between quantum nodes.

26. The method of claim 17, wherein
the plurality of quantum modules collectively define a curved or helical three-dimensional routing structure.

27. The method of claim 17, wherein the quantum computing system further comprises one or more inter-module interfaces, each inter-module interface coupled to a corresponding mounted quantum module and configured to transmit quantum information to and from the corresponding quantum module, and wherein each inter-module interface comprises at least one of:
an optical interface;
an electrical interface; or
a hybrid quantum–classical communication interface.

28. A method for controlling a quantum computing system comprising a plurality of quantum modules, the method comprising:
determining, for each quantum task allocated to at least one selected quantum module, a task migration desirability score or ranking; and
selecting, based on the task migration desirability score or ranking, at least one quantum task to be reallocated from quantum tasks allocated to the at least one selected quantum module.

29. The method of claim 28, further comprising:
determining a respective safe time for migration of each of the at least one quantum task; and
migrating the at least one quantum task to one or more remaining quantum modules at their respective safe times.
